(19) United States
(12) Patent Application Publication
(10) Pub. No.: US 2009/0164540 A1
(43) Pub. Date: Jun. 25, 2009

(54) APPARATUS AND METHOD FOR UPDATING CHECK NODE OF LOW DENSITY PARITY CHECK CODE

(75) Inventors: Jong-Ee OH, Daejon (KR); Minho CHEONG, Daejon (KR); Il-Gu LEE, Seoul (KR); Sok-Kyu LEE, Daejon (KR)

Correspondence Address: CANTOR COLBURN, LLP, 20 Church Street, 22nd Floor, Hartford, CT, 06103, US

(73) Assignee: Electronics and Telecommunications Research Institute, Daejon (KR)

(21) Appl. No.: 12/146,195

(22) Filed: Jun. 25, 2008

(30) Foreign Application Priority Data
Dec. 19, 2007 (KR) 10-2007-0133822

(51) Int. Cl. G06F 7/38

(52) U.S. Cl. 708/207

(57) ABSTRACT

Provided is an apparatus and method for updating a check node of a LDPC code at a high speed. The apparatus includes: a minimum value calculating unit for calculating a first minimum value of an input bit by sequentially calculating each bit of the first minimum value, and calculating a second minimum value using the calculated first minimum value; a node minimum value calculating unit for performing row splitting the calculated first and second minimum values by a check node and calculating a first minimum value and a second minimum value of each of the row-split nodes; and a minimum value deciding unit for deciding one of the calculated first and second minimum values of each of the row-split nodes as a minimum value corresponding to each degree of the input bit.

### CROSS-REFERENCE TO RELATED APPLICATIONS

The present invention claims priority of Korean Patent Application No. 10-2007-0133822, filed on Dec. 19, 2007, which is incorporated herein by reference.

### BACKGROUND OF THE INVENTION

1. Field of the Invention

The present invention relates to an apparatus and method for updating a check node of a low density parity check (LDPC) code at a high speed; and, more particularly, to an apparatus and method for updating a check node of a LDPC code at a high speed, which calculate a first minimum value and a second minimum value of an input bit and decide a minimum value corresponding to each degree of a check node using the calculated first and second minimum values, thereby effectively updating the check node.

This work was supported by the IT R&D program of MIC/IITA [2006-S-002-02, “IMT-Advanced Radio Transmission Technology with Low Mobility”].

2. Description of Related Art

In a wired/wireless communication system, a transmitted signal experiences noise, interference, and fading on a transmission channel. Therefore, a receiving end may have difficulty to demodulate the transmitted signal.

An error correction code is one of representative methods for reducing an error generation rate which increases in proportion to a transmit rate. Lately, almost wireless communication systems adopt the error correction code. Particularly, a low density parity check (LDPC) code has been receiving attention as an error correction code for a next generation high capacity wireless communication system because the LDPC code provides excellent error correction performance and enables a high speed decoder to be embodied with low complexity.

A LDPC code was introduced by Gallager. The LDPC code is defined as a matrix formed of 1s and 0s as elements. In the matrix, most elements are 0s and few elements are 1s.

The LDPC code is classified into a regular LDPC code and an irregular LDPC code. The regular LDPC code is a LDPC code introduced by Gallager. In a parity check matrix of the regular LDPC code, all rows have the same number of 1s and all columns also have the same number of 1s. On the contrary, a parity check matrix of the irregular LDPC code includes rows having the different number of 1s and columns having the different number of 1s. In general, it was widely known that the error correction performance of the irregular LDPC code is better than that of the regular LDPC code.

Meanwhile, a Quasi-cyclic LDPC code was introduced by Fossorier. In the Quasi-cyclic LDPC code, elements of a parity check matrix are expressed as cyclic-shifted identity matrices and 0 matrices instead of 0s and 1s which are elements of a matrix.

As a method for decoding the LDPC code, a serial or partial parallel decoding method and a parallel decoding method were introduced.

Since the serial or partial parallel decoding method repeatedly uses the small number of common blocks for processing a variable node and a check node, it is possible to advantageously reduce a hardware size. However, the serial or partial parallel decoding method cannot support high speed decoding.

On the contrary, the parallel decoding method can advantageously support high speed decoding by exchanging information in parallel through variable node processing blocks and check node processing blocks, which are optimized to each parity check matrix. However, the parallel decoding method also has a disadvantage of a large hardware size. That is, the larger the hardware size increases, the more various code rates are supported.

Meanwhile, a wired/wireless communication system must use an error correction code having a variable information length and a variable code rate in order to adaptively use modulation and coding scheme (MCS) according to a channel state. Therefore, various decoding methods for supporting various MCS levels were introduced, for example, a method for embodying independent decoders according to each of information lengths and code rates or a method for applying an information shortening scheme or a puncturing scheme although one hardware is used.

However, the former method has a shortcoming of a large hardware size, and the later method has a disadvantage that error correction performance of a LDPC code significantly deteriorates because of randomly using one of the information shortening scheme and the parity puncturing scheme.

As described above, the parallel decoding method is better for a high speed wireless communication system supporting a fast processing speed of several giga bits per second. Lately, it has been required to use a LDPC code having a variable information length and a variable code rate having excellent error correction performance in order to effectively apply an adaptive modulation and demodulation scheme. It has been also required that the complexity of encoding and decoding of the LDPC code must be low.

However, it is not easy to process entire LDPC codes in parallel due to high complexity of random connection of variable nodes and check nodes. Also, the decoding method for the conventional parallel processing method has a problem of unnecessary using a memory because a predetermined space for storing a variable node and a check node for parallel processing.

Hereinafter, a check node updating process according to the related art will be described.

At first, Equation 1 shows a variable node updating process of a Sum-Product Algorithm which is used for decoding a LDPC code.

$${v}_{j} = {\sum }_{i = 0 , i \neq j}^{{d}_{v}} {u}_{i} + {LLR}_{channel} \qquad Eq . 1$$

In Equation 1, LLR_{channel} denotes a log likelihood ratio (LLR) calculated by a demodulator. Also, dᵥ denotes a degree of a variable node, uᵢ is an i^{th} input LLR of a variable node, and vⱼ is a j^{th} output LLR of a variable node.

As shown in Equation 1, the variable node updating process is calculation of a j^{th} output LLR of a variable node. Since the j^{th} output LLR of a variable node is expressed as a sum of input values, the variable node updating process may be simply embodied by adding dᵥ inputs together and subtracting an j^{th} input value uⱼ from the adding result.

Equation 2 shows a check node updating process of a Sum-Product algorithm.

$$tanh \frac{{u}_{i}}{2} = {{∐}^{{d}_{c}}}_{j = 1 , j \neq i} tanh \frac{{v}_{j}}{2} \qquad Eq . 2$$

In Equation 2, d_{c} is a degree of a check node, vⱼ is a j^{th} input LLR of a check node, and uᵢ denotes a i^{th} output LLR of a check node.

As shown in Equation 2, the check node updating process is calculation of a hyperbolic tangent of an i^{th} output LLR of a check node. The hyperbolic tangent value of the i^{th} output LLR is expressed as multiplication of hyperbolic tangent values. Therefore, it is difficult to embody the multiplication of the hyperbolic tangent values in hardware.

In order to reduce the complexity of the check node updating process according to the related art, many methods were introduced. Among them, Equation 2 can be expressed as Equation 3.

$$log ( tanh \frac{{u}_{i}}{2} ) = {\sum }_{j = 1 , j \neq i}^{{d}_{c}} log ( tanh \frac{{v}_{j}}{2} ) \qquad Eq . 3$$

In Equation 3, d_{c} denotes a degree of a check node, vⱼ is an j^{th} input LLR of a check node, and uᵢ denotes an i^{th} output LLR of a check node.

In the check node updating process of Equation 3, the multiplication of the hyperbolic tangent values is calculated using a Look-up table like Equation 2 although the multiplication of the hyperbolic tangent values may be transformed to a summation operation.

Equations 4, 5, and 6 show a check node updating process introduced to eliminate the complicated process of multiplying the hyperbolic tangent values.

$${u}_{i} = ( {{∐}^{{d}_{c}}}_{j = 1 , j \neq i} sgn ( {v}_{j} ) ) {{min}^{{d}_{c}}}_{j = 1 , j \neq i} \vert {v}_{j} \vert \qquad Eq . 4$$

In Equation 4, sgn is a function that outputs +1 if an input is a positive number and outputs −1 if an input is a negative number. min denotes a function that output a minimum value among inputs.

Equation 4 denotes a “Min-Sum” algorithm. The “Min-Sum” algorithm calculates an i^{th} output LLR(uᵢ) of a check node using a code of a j^{th} input LLR(vⱼ) of a code and a minimum value.

$${u}_{i} = ( {{∐}^{{d}_{c}}}_{j = 1 , j \neq i} sgn ( {v}_{j} ) ) {{min}^{{d}_{c}}}_{j = 1 , j \neq i} ( α \cdot \vert {v}_{j} \vert ) \qquad Eq . 5$$

In Equation 5, α denotes a normalization value.

Equation 5 is a normalized “Min-Sum” algorithm which is a normalized version of the “Min-Sum” algorithm shown in Equation 4.

$${u}_{i} = ( {{∐}^{{d}_{c}}}_{j = 1 , j \neq i} sgn ( {v}_{j} ) ) {{min}^{{d}_{c}}}_{j = 1 , j \neq i} ( min ( \vert {v}_{j} \vert - β , 0 ) ) \qquad Eq . 6$$

In Equation 6, β denotes an offset value.

Equation 5 denotes an offset “Min-Sum” algorithm which is equivalent to the “Min-Sum” algorithm of Equation 4 using an offset value β.

In Equations 4, 5, and 6, an output sign can be obtained using XOR. It is comparatively easier to be embodied as hardware because the multiplication of hyperbolic tangent values can be replaced as the calculation of first and second minimum values from the d_{c} input absolute values where d_{c} is the degree of the check node.

However, if the degree increases, it is also even difficult to embody the calculation of the first and second minimum values as hardware in the check node updating process according to the related art. If the degree increases, complexity and a processing speed thereof also increase.

### SUMMARY OF THE INVENTION

An embodiment of the present invention is directed to providing an apparatus and method for updating a check node of a LDPC code at a high speed, which calculate a first minimum value or a second minimum value of an input bit by a bit and decide a minimum value corresponding to each degree of a check node using the calculated first and second minimum values, thereby effectively updating the check node.

In accordance with an aspect of the present invention, there is provided an apparatus for updating a check node of a low density parity check (LDPC) code at a high speed, including: a minimum value calculating unit for calculating a first minimum value of an input bit by sequentially calculating each bit of the first minimum value, and calculating a second minimum value using the calculated first minimum value; a node minimum value calculating unit for performing row splitting the calculated first and second minimum values by a check node and calculating a first minimum value and a second minimum value of each of the row-split nodes; and a minimum value deciding unit for deciding one of the calculated first and second minimum values of each of the row-split nodes as a minimum value corresponding to each degree of the input bit.

In accordance with another aspect of the present invention, there is provided a method for updating a check node of a low density parity check (LDPC) code at a high speed, including: calculating a first minimum value of an input bit by sequentially calculating each bit of the first minimum value, and calculating a second minimum value using the calculated first minimum value; performing row splitting the calculated first and second minimum values by a check node and calculating a first minimum value and a second minimum value of each of the row-split nodes; and deciding one of the calculated first and second minimum values of each of the row-split nodes as a minimum value corresponding to each degree of the input bit.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a factor graph of a low density parity check matrix having a typical option.

FIG. 2 is a diagram illustrating a sign bit calculator having in a check node of a typical low density parity check matrix.

FIGS. 3A and 3B are diagrams illustrating a minimum value calculator for calculating a first minimum value and a second having a row split option.

FIG. 4 is a diagram illustrating a high speed check node updating apparatus in accordance with an embodiment of the present invention.

FIG. 5 is a diagram illustrating a first minimum calculator of FIG. 4 in accordance with en embodiment of the present invention.

FIG. 6 is a diagram illustrating a third minimum calculator of FIG. 4 in accordance with an embodiment of the present invention.

FIG. 7 is a flowchart illustrating a method for updating a check node of a LPDC code at high speed in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

In order to embody a decoder for a LDPC code, it is necessary to express log likelihood ratio (LLR) values, transferred from each of edges, as x-bits through quantization.

Performance and complexity of the LDPC code decoder depend on a quantization method and the number of bits. In case of using the normalized “Min-Sum” algorithm, the performance may be influenced by a normalization factor. In case of using the offset “Min-Sum” algorithm, the performance may be influenced by an offset value.

Although it is possible to apply an apparatus and method for updating a check node of a low density parity check (LDPC) code according to an embodiment of the present invention to the “Min-Sum” algorithm, the normalized “Min-Sum” algorithm, and the offset “Min-Sum” algorithm regardless of a quantization method and a parameter value, the apparatus and method according to the present embodiment will be described to be applied to the offset “Min-Sum” algorithm.

In order to describe the present invention, assumptions are made as follows. A degree of a check node is 24. If row split is applied to the check node, the check node is divided into two nodes each having a degree of 12. In this case, the number of parity bits of a parity check matrix becomes twice than that of the parity check matrix before the row split.

The number of quantized bits in a message is 5 bits. In this case, 1-bit is used as a sign bit and 4-bits are used as a magnitude bit to update a check node.

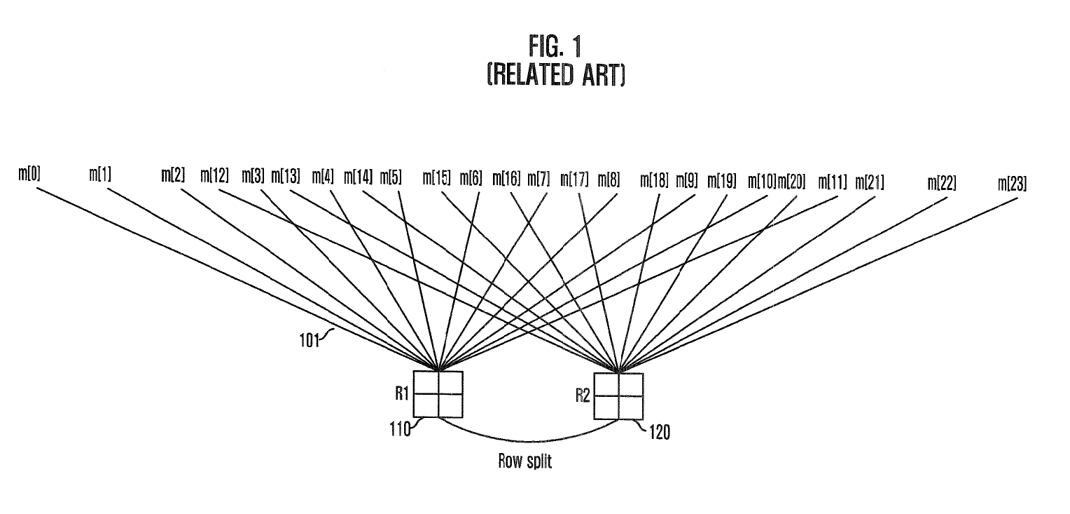

FIG. 1 is a diagram illustrating a factor graph of a typical low density parity check (LDPC) matrix having a row split option.

In a factor graph of a LDPC code, a check node 101 has a degree of 24. As shown in FIG. 1, the check node 101 can be row-split into two check nodes R1 and R2 each of which has a degree of 12. That is, if row split is applied, the check node is split to two check nodes 110 and 120 each having 12 degrees. If not, the check node becomes one check node having a degree of 24.

A process of updating each check node R1 or R2 is equivalent to a process of calculating an i^{th} output LLR (us) of a check node based on the offset “Min-Sum” algorithm of Equation 6. That is, in the process of updating each of the check nodes R1 and R2, each input LLR of a check node is corrected using an offset, a minimum value is selected from j^{th} input LLR (vⱼ), and the selected minimum value is decided as the i^{th} output LLR (uᵢ) of a check node.

The minimum value may be calculated through a process of calculating a first minimum value and a second minimum value from d_{c} input absolute values where d_{c} denotes the degree of the check node. For example, in an update process for calculating a fifth output LLR of a check node in the check node R1, first and second minimum values are selected from input LLRs m[0], m[1], . . . , and m[11]. If the first minimum value is the fifth input LLR, the second minimum value is decided as the fifth output LLR. If the first minimum value is not the fifth input LLR, the first minimum value is decided as the fifth output LLR. This process is identically applied to input LLRs m[12], m[13], . . . , and m[23], which are inputted to the second check node R2.

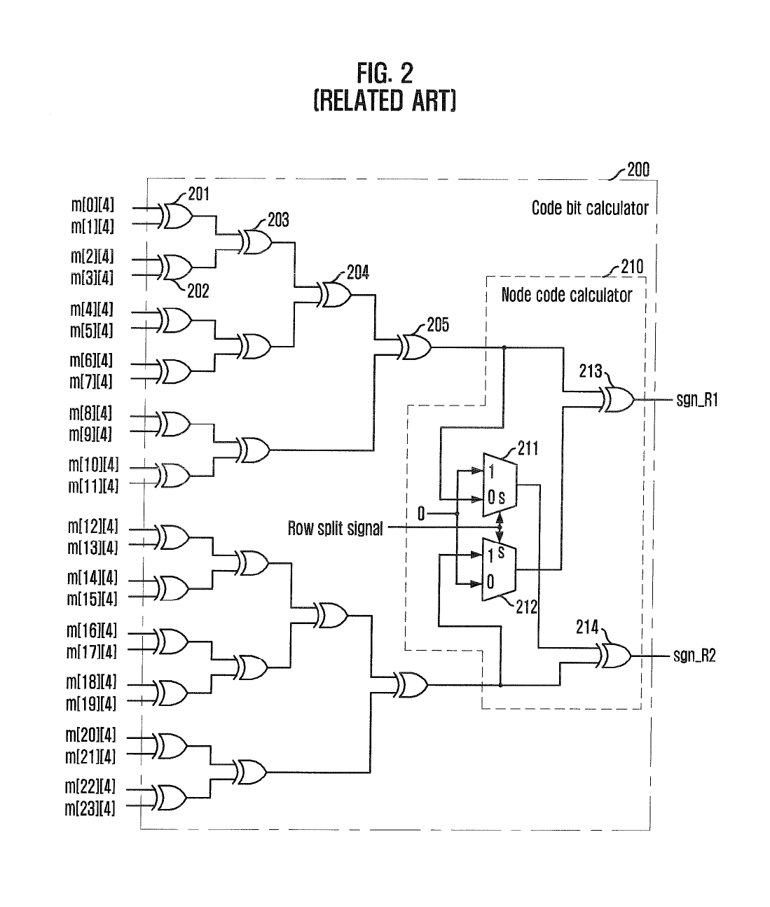

FIG. 2 is a diagram illustrating a sign bit calculator having a row split option in a check node of a LDPC matrix.

As shown in FIG. 2, the sign bit calculator 200 includes a plurality of XOR gates and a node sign calculator 210. The node sign calculator 210 includes multiplexers 211 and 212 and XOR gates 213 and 214. It is assumed that the sign bit calculator uses the most significant bit (MSB) which is m[i][4] as a sign bit if a LLR inputted to a check node is expressed as 5-bits m[1].

The sign bit calculator 200 row-splits a check node having a degree of 24 to two check nodes R1 100 and R2 120 each having a degree of 12 and calculates sign bits sgn_R1 and sgn_R2 for the check nodes 110 and 120.

A process of calculating a sign bit will be described. For example, a XOR gate 201 calculates a sign bit by performing an XOR operation on a 0^{th} sign bit m[0] [4] and a 1^{st} sign bit m[1] [4]. Using the same process, a XOR gate 202 calculates a sign bit by performing an XOR operation on a 2^{nd} sign bit m[2] [4] and a 3^{rd} sign bit m[3][4]. A XOR gate 203 calculates a sign bit by performing an XOR operation on the sign bits calculated from the XOR gates 201 and 202. As described above, the plurality of XOR gates 201 to 205 m[0][4] to m[11][4] calculate a sign bit by performing an XOR operation.

A plurality of another XOR gates calculate sign bits by performing an XOR operation on m[12][4] to m[23][4].

Here, if the row split option is not applied, a sign bit sgn_R1 of the check node R1 has the same value of the sign bit sgn_R2 of the check node R2. If the row split option is applied, the node sign calculator 210 calculates a sign bit sgn_R1 of the check node R1 and a sign bit sgn_R2 of a check node R2 by receiving a sign bit calculated through the XOR operation and a row split signal.

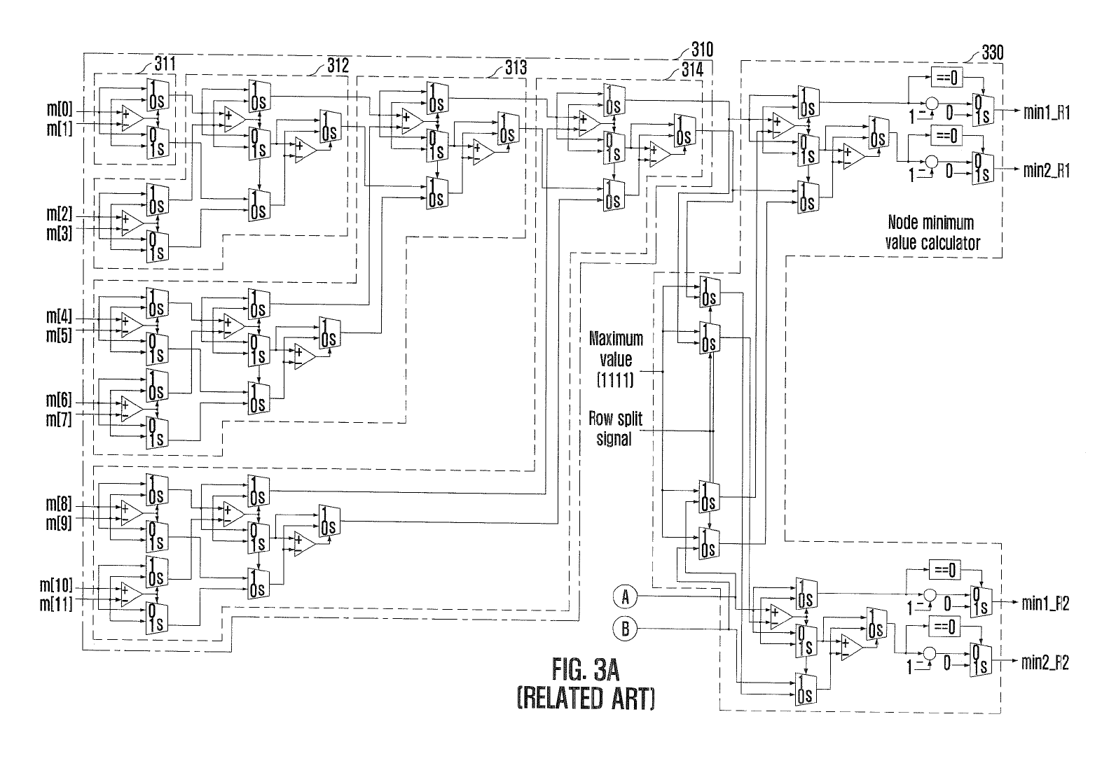

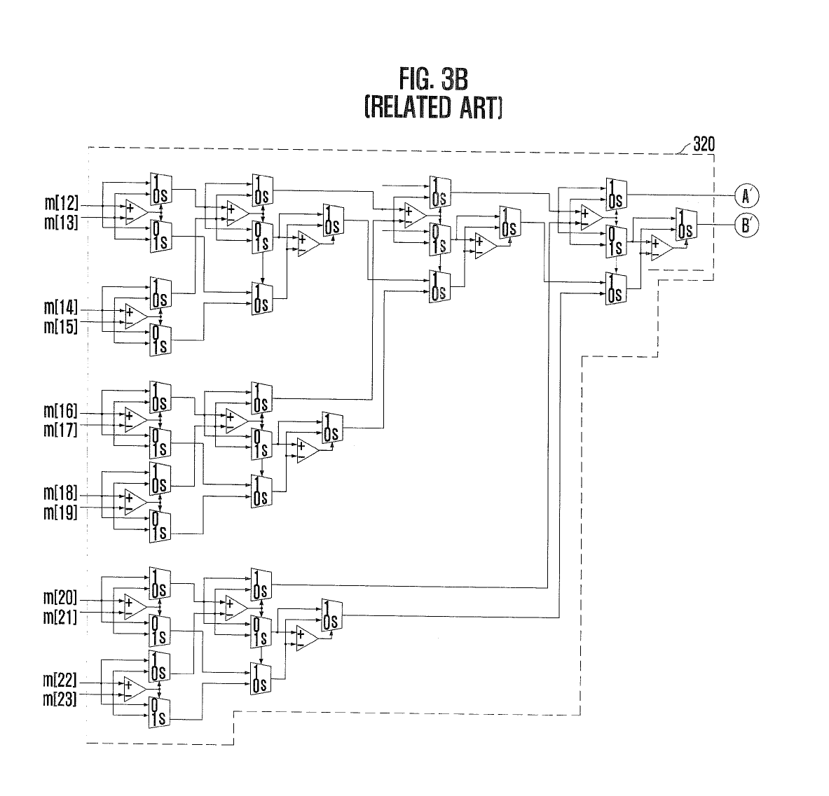

FIGS. 3A and 3B are diagrams illustrating a minimum value calculator for calculating a first minimum value and a second minimum value having a row split option in a check node updating apparatus according to the related art. Here, A and B in FIG. 3A are connected to A′ and B′ of FIG. 3B as A-A′ and B-B′.

As shown in FIGS. 3A and 3B, the minimum value calculator according to the related art includes a first minimum value calculating unit 310, a second minimum value calculating unit 320, and a node minimum value calculating unit 330. The minimum value calculator according to the related art has a row split option for row-splitting a check node with a degree of 24 into two check nodes R1 and R2 with a degree of 12. Among 5-bits, m[i] is expressed as 4-bits that denote magnitude, except the most significant bit denoting a sign. Here, the first minimum calculating unit 310 includes a first minimum value calculator 311, a second minimum value calculator 312, a third minimum value calculator 313, and a fourth minimum value calculator 314.

The minimum value calculator according to the related art uses an offset value of the offset “Min-Sum” algorithm of Equation 6 as a quantization step “1” and repeatedly calculates first and second minimum values among four inputs.

The first minimum value calculating unit 310 calculates a first minimum value and a second minimum value of input bits m[0] and m[1], m[2] and m[3], m[4] and m[5], m[6] and m[7], m[8] and m[9], and m[10] and m[11] using a plurality of multiplexers and a plurality of comparators. Then, the first minimum value calculator 310 calculates a first minimum value and a second minimum value from m[0] and m[11] through tournament.

In more detail, the first minimum value calculator 311 calculates a first minimum value and a second minimum value of input bits m[0] and m[1].

The second minimum value calculator 312 calculates first and second minimum values of input bits m[2] and m[3] and calculates first and second minimum values among m[0] to m[3] using the calculated first and second minimum values of the input bits m[2] and m[3].

The third minimum value calculator 312 calculates first and second minimum values of input bits m[4] to m[7] and calculates first and second minimum values among m[0] to m[7] using the calculated first and second minimum values of the input bits m[4] to m[7].

The fourth minimum value calculator 314 calculates first and second minimum values of input bits m[8] to m[11] and calculates first and second minimum values among m[0] to m[11] using the calculated first and second minimum values of the input bits m[8] to m[11].

According to the described method, a second minimum value calculator 320 shown in FIG. 3B calculates first and second minimum values from m[12] to m[23].

If row split is not applied, the first minimum value min1_R1 of the check node R1 is identical to the first minimum value min1_R2 of the check node R2. Also, the second minimum value min2_R1 of the check node R1 is identical to the second minimum value min2_R2 of the check node R2.

On the contrary, if row split is applied, the node minimum value calculating unit 330 receives the first and second minimum values among m[0] to m[11] from the first minimum value calculating unit 310 and also receives the first and second minimum values among m[12] to m[23] from the second minimum value calculating unit 320. The node minimum value calculating unit 330 calculates first and second minimum values min1_R1 and min2_R1 of the check node R1 and first and second minimum values min1_R2 and min2_R2 of a check node R2 by performing row-split using the inputted minimum values, a plurality of comparators, and a plurality of multiplexers. Here, if the min1_R1 is identical to each of m[0] to m[11], the min2_R1 is decided as output magnitude. If the min1_R1 is different, the min1_R1 is decided as output magnitude. Also, if the min1_R2 is identical to each of m[12] to m[23], the min2_R2 is decided as output amplitude. If not, the min1_R2 is decided as output amplitude.

In the minimum value calculating unit according to the related art shown in FIGS. 3A and 3B, the number of comparisons increases by geometric progression as the number of inputs increases. For example, the minimum value calculator according to the related art must operate 16 4-bit comparators through 7 steps in a time domain for 12 input bits m[0] to m[11]. Particularly, the row degree of the LPDC code further increases as a code rate increases. Therefore, a process for calculating a minimum value is needed to be performed efficiently.

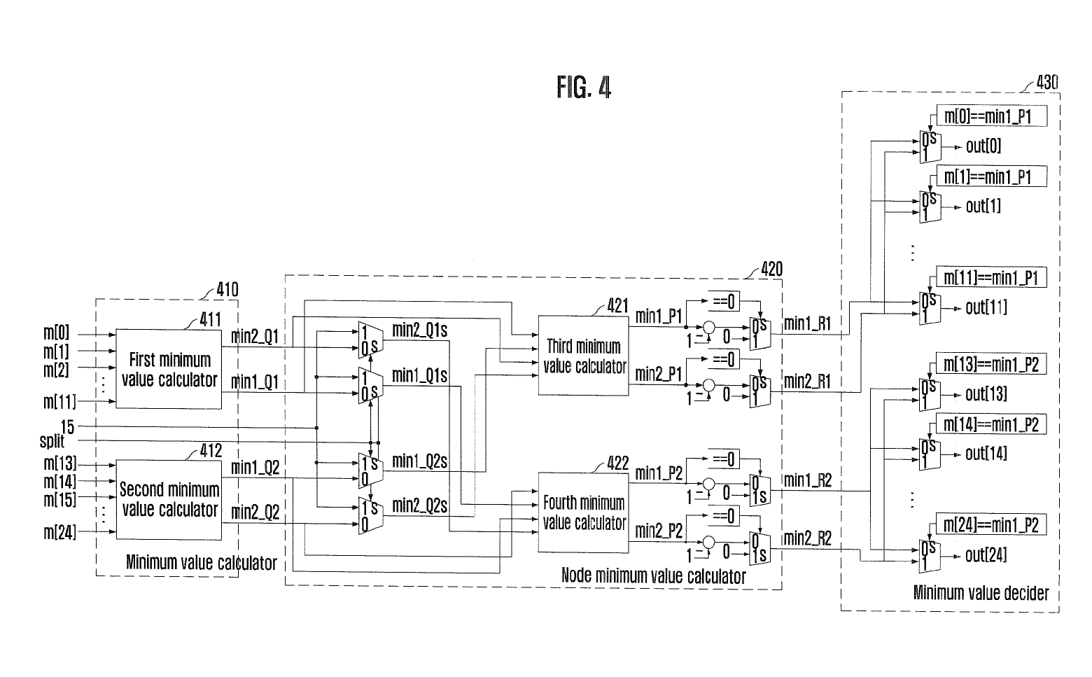

FIG. 4 is a diagram illustrating an apparatus for updating a check node of a low density parity check (LDPC) code at a high speed in accordance with an embodiment of the present invention.

As shown in FIG. 4, the apparatus for updating a check node at a high speed according to the present embodiment includes a minimum value calculator 410, a node minimum value calculator 420, and a minimum value decider 430. The minimum value calculator 410 includes a first minimum value calculator 411 and a second minimum value calculator 412. The node minimum value calculator 420 includes a third minimum value calculator 421, a fourth minimum value calculator 422, a plurality of multiplexers, and a plurality of subtractors. Also, the minimum value decider 430 includes a plurality of multiplexers.

Hereinafter, the constituent elements of the apparatus for updating a check node in accordance with an embodiment of the present invention will be described.

The minimum value calculator 410 calculates each bit of a first minimum value min1_Q1 and min1_Q2 of an input bit through the first and second minimum value calculators 411 and 412. The minimum value calculator 410 also calculates second minimum values min2_Q1 and min2_Q2 using the calculated first minimum values min1_Q1 and min1_Q2. That is, the minimum value calculator 410 calculates first minimum values min1_Q1 and min1_Q2, and calculates the second minimum values min2_Q1 and min2_Q1 using the calculated first minimum values min1_Q1 and min1_Q2 for a check node of a LDPC code having a row split option for row splitting a 24-degree check node to two 12-degree check nodes. Here, it is assumed that m[i] is 4-bits that denote magnitude among 5-bits except a most significant bit (MSB) of 5-bits, which denotes a sign.

The node minimum value calculator 420 receives the calculated first and second minimum values min1_Q1, min1_Q2, min2_Q1, and min2_Q1 from the minimum value calculator 410 and a row split signal and calculates first and second minimum values min1_P1 and min2_P1 for a check node R1 and first and second minimum values min1_P2 and min2_P2 for a check node R2 with the row split option applied. The node minimum value calculator 420 calculates first and second minimum values min1_R1, min1_R2, min2_R1, and min2_R2 for the check nodes R1 and R2. And the node minimum value calculator 420 updates minimum value by applying an offset to the minimum value. If the row split option is not applied, the first minimum values min1_R1 and min1_R2 of the check nodes R1 and R2 are identical. And, the second minimum values min2_R1 and min2_R2 for the check nodes R1 and R2 are the same.

The minimum value decider 430 calculates a check node output value by deciding one of the first minimum values min1_R1 and min1_R2 and the second minimum values min2_R1 and min2_R2 as a minimum value of each degree. That is, if each input bit m[i] is identical to the first minimum value min1_P1 and min1_P2 of a check node with the row split applied, the minimum value decider 430 decides the first minimum values min1_R1 and min1_R2 as a minimum value of a corresponding degree. If not, the minimum value decider 430 decides the second minimum value min2_R1 and min2_R2 as a minimum value of a corresponding degree.

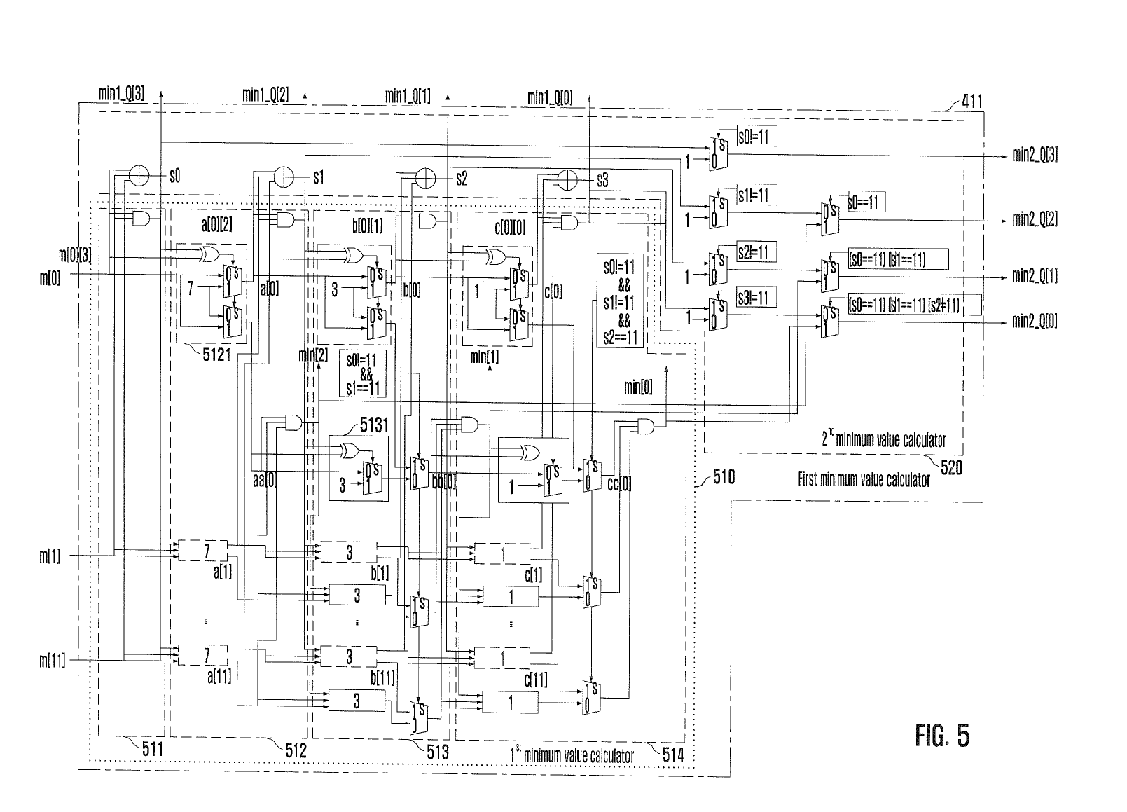

FIG. 5 is a diagram illustrating a first minimum value calculator of FIG. 4 in accordance with an embodiment of the present invention.

As shown in FIG. 5, the first minimum value calculator 411 of FIG. 4 according to the present embodiment includes a first minimum value calculator 510 and a second minimum value calculator 520. Here, the first minimum value calculator 510 includes a first bit processor 511, a second bit processor 512, a third bit processor 513, and a fourth bit processor 514. Each of the first to fourth bit processors 511 to 514 includes a plurality of XOR gates, a plurality of multiplexers, and a plurality of AND gates.

The first minimum value calculator 510 receives 12 input bits m[0] to m[11] for a check node R1. Then, the first minimum value calculator 510 calculates the most significant bit of a first minimum value using most significant bits of each input bit. Then, the first minimum value calculator 510 calculates other bits of a first minimum value sequentially from a next bit of the most significant bit to a least significant bit (LSB) using the calculated most significant bit of the first minimum value.

In more detail, the first bit processor 511 calculates a most significant bit min1_Q1[3] of a first minimum value by performing an AND operation on most significant bits m[0] [3] to m[11][3] of 12 input bits.

The second bit processor 512 determines whether each input bit m[i] is a first candidate group bit a[i] of a minimum value or not using a plurality of first calculating blocks 5121 with the most significant bit min1_Q1[3] of the first minimum value calculated from the first bit processor 511. The second bit processor 512 calculates a second bit min_Q[2] of the first minimum value by performing an AND operation on a second bit a[i][2] of the first candidate group bit a[i]. Here, the calculating block 5121 includes a XOR gate and a multiplexer.

In the first candidate group determination process, if the most significant bit min1_Q1[3] of the first minimum value is identical to the most significant bit m[i][3] of each input bit, the second bit processor 512 determines each input bit as the first candidate group using an XOR gate and a multiplexer and passes the input bit m[i] as it is as the first candidate group bit a[i]. On the contrary, if the second bit processor 512 determines that the most significant bit min1_Q1[3] is different from the most significant bit m[i][3] of each input bit, the second bit processor 512 changes it to the first maximum bit aa[i], for example, 7, and transfers the first maximum bit aa[i] to the third bit processor 513.

The three bit processor 513 receives the first candidate group bit a[i] for each input bit and the first maximum bit aa[i] from the second bit processor 512 and determines whether each first candidate group bit a[i] is a minimum value of a second candidate group bit b[i] using a plurality of first calculating blocks 5121 and a plurality of second calculating blocks 5131. The third bit processor 513 calculates a third bit min_Q[1] of a first minimum value by performing an AND operation on a third bit b[i] [1] of the second candidate group bit b[i].

The fourth bit processor 514 receives a second candidate group bit b[i] for each bit and a second maximum bit bb[i] from the third bit processor 513 and determines whether the second candidate bit b[i] is a minimum value of the third candidate bit c[i] using a plurality of calculating blocks 5121 and a plurality of second calculating blocks 5131. The fourth bit processor 514 calculates a fourth bit min_Q[0] of a first minimum value by performing an AND operation on the fourth bit c[i][1] of the third candidate bit c[i].

The second minimum value calculator 520 sets up an input bit m[i] corresponding to the first minimum value min1_Q1 calculated by the first minimum value calculator 510 as the maximum value and calculates a second minimum value min2_Q1 from the most significant bit (MSB) to the least significant bit (LSB) through the minimum value calculating process. That is, the second minimum value calculator 520 calculates each bit of the second minimum value sequentially from the MSB to LSB by comparing a sum which is calculated sequentially from the MSB to the LSB of input bits with a number one smaller than the number of input.

In more detail, the second minimum value calculator 520 calculates a first result value s0 by calculating a sum of most significant bits m[i][3] of input bits m[i], calculates a second result value s1 by calculating a sum of second bits a[i][2] of the first candidate bit a[i], calculates a third result value s2 by calculating a sum of third bits b[i] [2] of second candidate bits b[i], and fourth bits b[i] [2] of third candidate bits c[i].

The second minimum value calculator 520 compares the first result value s0 with 11 which is 1 less than the number of input bits, 12. If the first result value s0 is different from 11, the second minimum value calculator 520 decides the most significant bit min1_Q1[3] of the first minimum value as a most significant bit min2_Q1[3] of a second minimum value. If not, the second minimum value calculator 520 decides 1 as the most significant bit min2_Q[3] of the second minimum value.

The second minimum value calculator 520 compares the first and second result values s0 and s1 with 11. The second minimum value calculator 520 decides one of the second bit mini1_Q[2] of the first minimum value, a second bit min[2] of a minimum value of the first maximum bit aa[i], and 1 as a second bit min2_Q[2] of the second minimum value.

Then, the second minimum value calculator 520 compares the first to third result values s0 to s2 with 11. The second minimum value calculator 520 decides one of a third bit mini1_Q[1] of the first minimum value, a third bit min[1] of a minimum value of the second maximum bit bb[i], and 1 as the third bit min2_Q[1] of the second minimum value.

Then, the second minimum value calculator 520 compares the first to fourth result values s0 to s3 with 11. The second minimum value calculator 520 decides one of a fourth bit min1_Q[0] of the first minimum value, a second bit min[0] of a minimum value of the third maximum bit cc[i], and 1 as a fourth bit min2_Q[0] of the second minimum value.

Although FIG. 5 shows the process of calculating minimum values for the check node R1, the second minimum value calculator 412 can calculates the first minimum value min1_Q2 and the second minimum value min2_Q2 together by receiving input bits m[12] to m[23] for the check node R2.

Therefore, the minimum value calculator 410 can performs a minimum value calculating process at a high speed. If the number of input bits is small, it will be more effective. In case of a low density parity check (LDPC) code, the minimum value calculator according to the present embodiment will provide superior performance although 4-bit information is used as a magnitude bit for uniform quantization or although 3-bit information is used as a magnitude bit for non-uniform quantization.

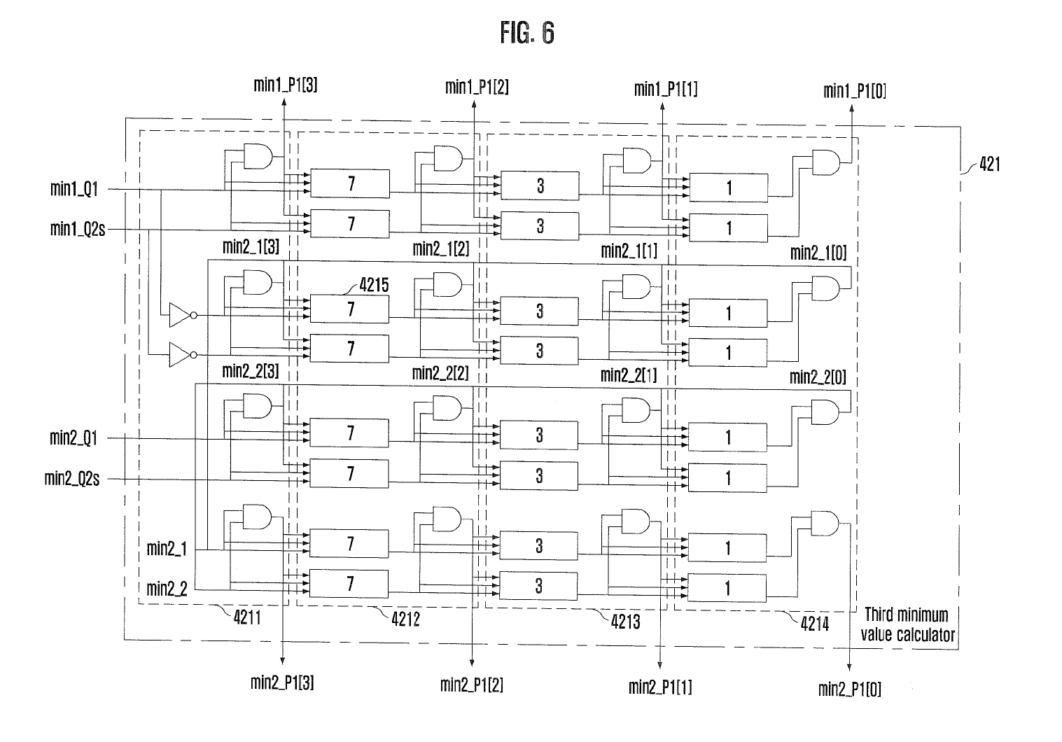

FIG. 6 is a diagram illustrating fourth and third minimum value calculator in accordance with an embodiment of the present invention.

As shown in FIG. 6, the third minimum value calculator 421 of FIG. 4 includes a first bit calculator 4211, a second bit calculator 4212, a third bit calculator 4213, and a fourth bit calculator 4214. The first to fourth bit calculators 4211 to 4214 include a plurality of AND gates, a plurality of NOT gates, and a plurality of calculating blocks 4215. The plurality of calculating blocks 4215 has the same structure of the calculating block 5131 of FIG. 5.

The third minimum calculator 421 receives four bits min2_Q1, min1_Q1s, min1_Q2, and min2_Q2s and calculates most significant bits min1_P1[3] and min2_P1[3] of first and second minimum values using the most significant bits of each bit. The third minimum value calculator 421 sequentially calculates least significant bits min2_P1[3] of first and second minimum values.

In more detail, the first bit calculator 4211 calculates a first minimum value and a second minimum value of most significant bits min1_P1[3] and min2_P1[3] among four bits min2_Q1, min1_Q1s, min1_Q2, and min2_Q2s using AND gates and NOT gates.

The second bit calculator 4212 calculates second bits min1_P1[2] and min2_P1[2] of first and second minimum values by applying the most significant bits min1_P1[3] and min2_P1[3] calculated by the first bit calculator 4211 to a plurality of calculating blocks 4215 and AND gates.

The third bit calculator 4213 calculates third bits min1_P1[1] and min2_P1[1] of first and second minimum values by applying the second bits min1_P1[2] and min2_P1[2] calculated from the second bit calculator 4212.

The fourth calculator 4214 calculates fourth bits min1_P1[0] and min2_P1[0] of first and second minimum values by applying the third bits min1_P1[1] and min2_P1[1] calculated from the third bit calculator 4213 to a plurality of calculating blocks 4215 and AND gates.

The fourth minimum value calculator 422 has the same structure of the third minimum value calculator 421 and calculates first and second minimum values min1_P2 and min2_P2 for a check node R2.

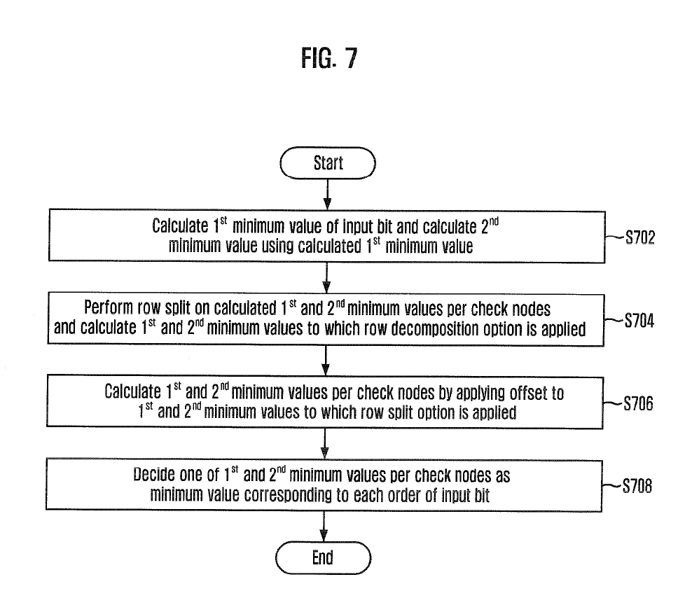

FIG. 7 is a flowchart illustrating a method for updating a check node of a low density parity check (LDPC) code at a high speed in accordance with an embodiment of the present invention.

At step S702, the minimum value calculator 410 calculates each bit of first minimum values min1_Q1 and min1_Q2 for an input bit through the first and second minimum value calculators 411 and 412 and calculates second minimum values min2_Q1 and min2_Q2 using the calculated first minimum values min1_Q1 and min1_Q2. Here, m[i] is four-bits that denote magnitude among 5-bits, except a most significant bit (MSB) thereof that denotes a sign.

In the step S702, the first and second minimum value calculators 411 and 412 calculates a most significant bit of a first minimum value using MSBs of each input bit. Then, first and second minimum value calculators 411 and 412 sequentially calculate other bits of the first minimum value using the calculated most significant bit of the first minimum value. That is, the first and second minimum value calculators 411 and 412 calculates the most significant bit of the first minimum value by performing an AND operation on the MSBs of each input bit, and sequentially calculates other bits of the first minimum value using the calculated MSB of the first minimum value according to whether each input bit is included in a candidate group of a minimum value or not.

The first and second minimum value calculators 411 and 412 set up an input bit corresponding to the calculated first minimum value as a maximum value and sequentially calculate each bit of a second minimum value from a most significant bit to a least significant bit through the minimum value calculating process. Also, the first and second minimum value calculators 411 and 412 calculates a sum by bits of the calculated first minimum value from the most significant bit to the least significant bit thereof, and sequentially calculates each bit of a second minimum value from the most significant bit to the least significant bit by comparing the sum with a value that one smaller than the number of the input bits.

Meanwhile, at step S704, the node minimum value calculator 420 calculates first and second minimum values min1_P1, min2_P1, min1_P2, and min2_P2 with a row split option applied by row-splitting the first and second minimum values min1_Q1, min1_Q2, min2_Q1, and min2_Q1, calculated from the minimum value calculator 410. Here, the node minimum value calculator 420 receives a row split signal Row Split and applies the row split option.

At step S706, the node minimum value calculator 420 calculates first minimum values min1_R1 and min1_R2 and second minimum values min2_R1 and min1_R2 for the check nodes R1 and R2 by applying an offset to the minimum value with the row split option applied. If the row split option is not applied, the first minimum values min1_R1 and min1_R2 of the check nodes R1 and R2 are identical and the second minimum values min2_R1 and min2_R2 of the check nodes R1 and R2 are identical too.

At step S708, the minimum value decider 430 decides one of the first and second minimum values min1_R1, min1_R2, min2_R1, and min2_R2 as a minimum value of each degree of an input bit and outputs the minimum value. That is, if each input bit m[i] is identical to the first minimum value min1_P1 and min1_P2 of the check nodes R1 and R2 with the row split option applied, the minimum value decider 430 decides the first minimum value min1_R1 and min1_R2 as the minimum value of corresponding degree. If not, the minimum value decider 430 decides the second minimum value min2_R1 and min1_R2 as the minimum value of a corresponding degree.

As described above, a first minimum value and a second minimum value of an input bit are calculated by each bit, and a minimum value of each degree of a check node is calculated using the calculated first and second minimum value in order to update a check node of a low density parity check (LDPC) code in the present embodiment. Therefore, the check node updating process can be effectively performed according to the present embodiment.

That is, it is possible to calculate a minimum value or first and second minimum values without making delay of a processing speed in a process of updating a check node of LDPC decoder using a “Min-Sum” algorithm, an offset “Min-Sum” algorithm, and a normalized “Min-Sum” algorithm. Only, the complexity thereof increases as the check node degree increases. It is also possible to update the check node at a high speed while reducing the complexity of hardware thereof compared to a conventional check node updating apparatus. Furthermore, the present invention may be applied to a field for effectively searching a minimum value beside of LDPC code decoding.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

While the present invention has been described with respect to the specific embodiments, it will be apparent to those skilled in the art that various changes and modifications may be made without departing from the spirit and scope of the invention as defined in the following claims.

What is claimed is:

1. An apparatus for updating a check node of a low density parity check (LDPC) code at a high speed, comprising:
a minimum value calculating means for calculating a first minimum value of an input bit by sequentially calculating each bit of the first minimum value, and calculating a second minimum value using the calculated first minimum value;
a node minimum value calculating means for performing row splitting the calculated first and second minimum values by a check node and calculating a first minimum value and a second minimum value of each of the row-split nodes; and
a minimum value deciding means for deciding one of the calculated first and second minimum values of each of the row-split nodes as a minimum value corresponding to each degree of the input bit.

2. The apparatus of claim 1, wherein the minimum value calculating means includes:
a first minimum value calculating unit for calculating the first minimum value of the input bit by sequentially calculating each bit of the first minimum value from a most significant bit to a lest significant bit; and
a second minimum value calculating unit for calculating the second minimum value using the calculated first minimum value by calculating each bit of the second minimum value from a most significant bit to a least significant bit.

3. The apparatus of claim 2, wherein the second minimum value calculating unit sets up an input bit corresponding to the calculated first minimum value as a maximum value and sequentially calculates each bit of the second minimum value from a most significant bit to a least significant bit.

4. The apparatus of claim 2, wherein the second minimum value calculating unit calculates a sum of bits of the calculated first minimum value from a most significant bit to a least significant bit and sequentially calculates each bit of the second minimum value from a most significant bit to a least significant bit by comparing the calculated sum with the number of the input bits.

5. The apparatus of claim 2, wherein the first minimum calculating means calculates a most significant bit of the first minimum value using most significant bits of the input bit and sequentially calculates other bits of the first minimum value using the calculated most significant bit.

6. The apparatus of claim 5, wherein the first minimum calculating means calculates a most significant bit of the first minimum value by performing an AND operation on most significant bits of the input bit and sequentially calculates other bits of the first minimum value using the calculated most significant bit according to whether the input bit is included in a candidate group of a minimum value or not.

7. A method for updating a check node of a low density parity check (LDPC) code at a high speed, comprising:
calculating a first minimum value of an input bit by sequentially calculating each bit of the first minimum value, and calculating a second minimum value using the calculated first minimum value;
performing row splitting the calculated first and second minimum values by a check node and calculating a first minimum value and a second minimum value of each of the row-split nodes; and
deciding one of the calculated first and second minimum values of each of the row-split nodes as a minimum value corresponding to each degree of the input bit.

8. The method of claim 7, wherein said calculating a first minimum value includes:
calculating the first minimum value of the input bit by sequentially calculating each bit of the first minimum value from a most significant bit to a lest significant bit; and
calculating the second minimum value using the calculated first minimum value by calculating each bit of the second minimum value from a most significant bit to a least significant bit.

9. The method of claim 8, wherein in said calculating the second minimum value, an input bit corresponding to the calculated first minimum value is set up as a maximum value and each bit of the second minimum value is sequentially calculated from a most significant bit to a least significant bit.

10. The method of claim 8, wherein in said calculating the second minimum value, a sum of bits of the calculated first minimum value from a most significant bit to a least significant bit is calculated, and each bit of the second minimum value is calculated sequentially from a most significant bit to a least significant bit by comparing the calculated sum with the number of the input bits.

11. The method of claim 8, wherein in said calculating the first minimum value, a most significant bit of the first minimum value is calculated using most significant bits of the input bit and other bits of the first minimum value are sequentially calculated using the calculated most significant bit.

12. The method of claim 11, wherein in said calculating the first minimum value, a most significant bit of the first minimum value is calculated by performing an AND operation on most significant bits of the input bit and other bits of the first minimum value are sequentially calculated using the calculated most significant bit according to whether the input bit is included in a candidate group of a minimum value or not.
